(19) United States
(12) Patent Application Publication
(10) Pub. No.: US 2024/0180840 A1
(43) Pub. Date: Jun. 6, 2024

(54) METHODS OF DESIGNING AN ORAL DRUG DOSAGE FORM BASED ON A TARGET PK PROFILE AND DOSAGE FORMS THEREOF

(71) Applicant: Triastek, Inc., Nanjing (CN)

(72) Inventors: Lihua CAO, Nanjing (CN); Xipan LIU, Nanjing (CN); Xin LIU, Nanjing (CN); Feihuang DENG, Nanjing (CN); Senping CHENG, Nanjing (CN); Xiaoling LI, Dublin, CA (US)

(21) Appl. No.: 18/550,432

(22) PCT Filed: Feb. 23, 2022
(86) PCT No.: PCT/CN2022/077513

§ 371 Date: Sep. 13, 2023

(30) Foreign Application Priority Data
Mar. 17, 2021 (WO) PCT/CN2021/081293
Mar. 31, 2021 (JP) 2021-061229
Aug. 30, 2021 (JP) 2021-139972

(51) Int. Cl. A61K 9/20; B82Y 10/00

(52) U.S. Cl. CPC A61K 9/2095; B82Y 10/00

(57) ABSTRACT

The present disclosure, in some aspects, is directed to methods of deisgning an oral drug dosage form formulated and configured to provide an efficacy-based target pharmocokinetic (PK) profile by optmizing the drug concentration-permeability interplay at any time and/or location in the gastrointestinal tract. In other aspects, the present disclosure is directed to oral drug dosage forms having the desired PK profile, and methods of making, such as three-dimentional printing, such oral drug dosage forms to release the drug (and any functional excipients) with the right amount, at the right time, and at the right location.

### TECHNICAL FIELD

The present disclosure, in some aspects, is directed to methods of designing an oral drug dosage form formulated and configured to provide a target pharmacokinetic (PK) profile. In other aspects, the present disclosure is directed to oral drug dosage forms having a desired pharmacokinetic profile, and methods of making, such as three-dimensional printing, such oral drug dosage forms.

### BACKGROUND

The increasingly complex of the mechanisms of drug and reagent disposition and action, coupled with the realization of inter-patient variability in drug and reagent disposition and response, increasingly illustrates the importance of precision in vivo drug delivery to ensure the drug or reagent reaches the intended location, at the intended time, and in the intended amount, achieving a pharmacokinetic profile that results in maximal efficacy and safety of said drugs, drug candidates, and reagents. To realize the desired therapeutic outcome, certain drugs and reagents may require achievement of a pharmacokinetic profile of the drug or reagent that can only be produced via specialized formulation that generate complex release profiles and/or facilitate unique dosing regimen. Designing a drug dosage form capable of achieving these unique pharmacokinetic profiles in an individual can be difficult for all but a select few drugs and reagents due to biopharmaceutical properties of many drugs and regents that render the use of traditional modeling and simulation design and testing methods unhelpful. Additionally, the manufacturing processes required to produce these complex release profiles and facilitate these unique dosing regimens for oral dosage forms often cannot be achieved using conventional tablet or capsule production methods.

All references cited herein, including patent applications and publications, are incorporated by reference in their entirety.

### BRIEF SUMMARY

In some aspects, provided herein is a method of designing an oral drug dosage form formulated and configured to provide a target pharmacokinetic (PK) profile for a drug in an individual, the method comprising: (a) determining a simulated drug release profile configured to obtain the target PK profile, wherein the simulated drug release profile comprises an amount of the drug released from the oral drug dosage form at a plurality of time points over a pre-determined time course, and wherein each time point of the simulated drug release profile is determined based on an amount of the drug absorbed at the time point, a permeability value for the drug in a specific location of the gastrointestinal (GI) tract where the oral drug dosage form is expected to be present after ingestion associated with the time point, and a liquid volume of the GI tract into which the drug could dissolve at the expected location associated with the time point; and (b) designing the oral drug dosage form to release the drug based on the simulated drug release profile thereby designing the oral drug dosage form formulated and configured to provide the target PK profile.

In some embodiments, the method further comprises determining the amount of the drug absorbed from the oral drug dosage form at each time point. In some embodiments, the amount of the drug absorbed from the oral drug dosage form at each time point is based on a drug absorption rate profile, wherein the drug absorption rate profile comprises an uptake rate of the drug at the plurality of time points to obtain the target PK profile. In some embodiments, the amount of the drug absorbed from the oral drug dosage form is based on Equation IV,

Q_{abs}(t)=q_{abs}(t)×Δt, Equation IV,

where Q_{abs}(t) is the amount of the drug absorbed from the oral drug dosage form as a function of time, and where q_{abs}(t) is the absorption rate of the drug as a function of time.

In some embodiments, the method further comprises determining the drug absorption rate profile. In some embodiments, the drug absorption rate profile is based on deconvolution, such as mathematical deconvolution, of the target PK profile with a disposition profile of a drug. In some embodiments, deconvolution is based on the Laplacian domain, such as shown in Equation I. In some embodiments, the drug absorption rate profile is based on deconvolution of the target PK profile with a disposition profile of the drug according to Equation I:

$${q}_{abs} ( t ) = {L}^{- 1} [ \frac{L \{ {C}_{p , oral} ( t ) \}}{L \{ {C}_{p , disposition} ( t ) \}} ] ,$$

Equation I, where L and L⁻¹ are Laplace transform and inverse Laplace transform, where q_{abs}(t) is based on the drug absorption rate profile as a function of time, and where C_{p,oral}(t) and C_{p,disposition}(t) are based on the plasma level concentration profile as a function of time of oral administration and disposition, respectively.

In some embodiments, the disposition profile of a drug comprises a plasma concentration of the drug at each of the plurality of time points when the drug is administered via a parenteral route. In some embodiments, the parenteral route is intravenous administration. In some embodiments, the method further comprises performing the deconvolution of the target PK profile with the disposition profile of the drug. In some embodiments, the disposition profile of a drug is a known profile. In some embodiments, the method further comprises obtaining the disposition profile of a drug.

In some embodiments, the method further comprises determining an amount of the drug required in a location of the GI tract from the oral drug dosage form at the time point, wherein the amount of drug required for absorption in a location of the GI tract from the oral drug dosage form at the time point is based on the permeability value for the drug at the expected location within the (GI) tract associated with the time point, and the liquid volume of the GI tract at a location associated with the time point.

In some embodiments, the method further comprises determining the drug concentration time or location profile. In some embodiments, the drug concentration time or location profile is based on the drug absorption rate profile and a drug permeability time or location profile, wherein the drug permeability time or location profile comprises the permeability value for the drug in a location of the (GI) tract associated with each time point of the plurality of time points. In some embodiments, the drug concentration time or location profile is based on Equation II,

q_{abs}(t/x)=C(t/x)×P(t/x), Equation II,

where C(t/x) is the concentration of the drug soluble in GI tract from the oral drug dosage form as a function of time or location, where q_{abs}(t/x) is the absorption rate of the drug as a function of time or location, and where P(t/x) is the permeability as a function of time or location.

In some embodiments, the amount of the drug required for absorption from the oral drug dosage form in a location of the GI tract at the time point is based on a drug concentration time or location profile and a GI liquid volume time or location profile. In some embodiments, the amount of the drug required in a location of the GI tract from the oral drug dosage form is based on Equation III,

Q_{GIT}(t/x)=C_{GIT}(t/x)×V_{GIT}(t/x), Equation III,

where Q_{GIT}(t/x) is the amount of the drug required for absorption from the oral drug dosage form as a function of the time or location, where C_{GIT}(t/x) is the concentration of the drug soluble for absorption from the oral drug dosage form as a function of the time or location, and where V_{GIT}(t/x) is the liquid volume of the GI tract as a function of the time or location.

In some embodiments, the GI liquid volume time or location profile is a known profile. In some embodiments, the method further comprises obtaining the GI liquid volume time or location profile. In some embodiments, the GI liquid volume time or location profile can reflect either a fed or fasting state of the individual when administering the oral drug dosage form.

In some embodiments, the drug permeability time or location profile is a known profile. In some embodiments, the method further comprises obtaining the drug permeability time or location profile.

In some embodiments, the method further comprises designing the oral drug dosage form based on a modulation of the solubility of the drug.

In some embodiments, the method further comprises designing the oral drug dosage form based on a modulation of the drug permeability time or location profile.

In some embodiments, the method further comprises optimizing the simulated drug release profile.

In some embodiments, the method further comprises determining a cumulated drug release profile based on the simulated drug release profile.

In some embodiments, the method further comprises obtaining the target PK profile.

In some embodiments, the target PK profile has at least a 90% confidence interval that falls within the range of about 80% to about 125% for a ratio of the AUC₀₋ₜ for a dosing regimen of the oral drug dosage form and a reference dosing regimen, where/is based on the pre-determined time course. In some embodiments, the target PK profile has at least a 90% confidence interval that falls within the range of about 80% to about 125% for the relative mean of a ratio of the AUC₀₋ₜ for a dosing regimen of the oral drug dosage form and a reference dosing regimen, where/is based on the pre-determined time course. In some embodiments, the target PK profile has at least a 90% confidence interval that falls within the range of about 80% to about 125% for a ratio of the Cₘₐₓ for a dosing regimen of the oral drug dosage form and a reference dosing regimen. In some embodiments, the target PK profile has at least a 90% confidence interval that falls within the range of about 80% to about 125% for the relative mean of a ratio of the Cₘₐₓ for a dosing regimen of the oral drug dosage form and a reference dosing regimen. In some embodiments, the target PK profile has at least a 90% confidence interval that falls within the range of about 80% to about 125% for a ratio of the C₂₄ₕ for a dosing regimen of the oral drug dosage form and a reference dosing regimen, where 24 h is 24 hours post-administration of the oral drug dosage form. In some embodiments, the target PK profile has at least a 90% confidence interval that falls within the range of about 80% to about 125% for the relative mean of a ratio of the C₂₄ₕ for a dosing regimen of the oral drug dosage form and a reference dosing regimen, where 24 h is 24 hours post-administration of the oral drug dosage form. In some embodiments, the target PK profile has an AUC₀₋ₜ, Cₘₐₓ, and Cₜ, within an acceptable threshold of a reference PK profile of a reference dosing regimen, where/is based on the pre-determined time course.

In some embodiments, the target PK profile is bioequivalent to a reference PK profile of a reference dosing regimen.

In other aspects, provided herein is a method of designing an oral drug dosage form formulated and configured to provide a target pharmacokinetic (PK) profile for a drug in an individual, the method comprising: (a) determining a drug absorption rate profile based on deconvolution of a target PK profile using a disposition profile of the drug, and a total amount of the drug in the oral drug dosage form; (b) determining a drug absorption amount profile based on the drug absorption rate profile; (c) determining a drug concentration time or location profile based on the drug absorption rate profile and a permeability time or location profile for the drug, (d) determining a GI drug requirement amount profile based on the drug concentration time or location profile and a GI liquid volume time or location profile; (e) determining a simulated drug release time or location profile configured to obtain the target PK profile based on the drug absorption amount profile and the GI drug requirement amount profile, wherein the simulated drug release profile comprises an amount of the drug released from the oral drug dosage form to obtain the target PK profile; and (f) designing the oral drug dosage form to release the drug based on the simulated drug release profile thereby designing the oral drug dosage form formulated and configured to provide the target PK profile.

In some embodiments, determining a drug absorption rate profile comprises deconvoluting the target PK profile with the disposition profile of a drug.

In other aspects, provided herein is an oral drug dosage form comprising a drug formulated and configured to have a target pharmacokinetic (PK) profile, wherein the oral drug dosage form is formulated and configured to release the drug based on a design obtained from any method described herein.

In other aspects, provided herein is a method of making an oral drug dosage form comprising a drug formulated and configured to have a target pharmacokinetic (PK) profile, the method comprising three-dimensional (3D) printing the oral drug dosage form based on a design of the oral drug dosage form obtained from any method described herein.

In other aspects, provided herein is a method of making an oral drug dosage form comprising a drug formulated and configured to have a target pharmacokinetic (PK) profile, the method comprising three-dimensional (3D) printing the oral drug dosage form based on a design of the oral drug dosage form obtained from a method comprising: (a) determining a drug absorption rate profile based on deconvolution of a target PK profile using a disposition profile of the drug, and a total amount of the drug in the oral drug dosage form; (b) determining a drug absorption amount profile based on the drug absorption rate profile; (c) determining a drug concentration time or location profile based on the drug absorption rate profile and a permeability time or location profile for the drug, (d) determining a GI drug requirement amount profile based on the drug concentration time or location profile and a GI liquid volume time or location profile; (e) determining a simulated drug release profile configured to obtain the target PK profile based on the drug absorption amount profile and the GI drug requirement amount profile, wherein the simulated drug release profile comprises an amount of the drug released from the oral drug dosage form to obtain the target PK profile; and (f) designing the oral drug dosage form to release the drug based on the simulated drug release profile thereby designing the oral drug dosage form formulated and configured to provide the target PK profile.

It will also be understood by those skilled in the art that changes in the form and details of the implementations described herein may be made without departing from the scope of this disclosure. In addition, although various advantages, aspects, and objects have been described with reference to various implementations, the scope of this disclosure should not be limited by reference to such advantages, aspects, and objects.

### BRIEF DESCRIPTION OF THE DRAWINGS

FIG. 1 depicts an example workflow of a design method disclosed herein for designing an oral drug dosage form formulated and configured to provide a target pharmacokinetic (PK) profile.

FIG. 2 depicts an overlay of a PK profile for twice daily (BID) administration of a reference immediate-release oral drug dosage form containing 5 mg of Drug A and a target PK profile for a once-daily administration of an extended-release oral drug dosage form containing 10 mg of Drug A.

FIG. 3 depicts example steps and profiles utilized in obtaining a drug absorption rate profile based on a target PK profile, a disposition profile of a drug, and information regarding the total amount of the drug in an oral drug dosage form.

FIG. 4 depicts example steps and profiles utilized in obtaining a drug absorption amount profile from a drug absorption rate profile.

FIG. 5A depicts example steps and profiles utilized in obtaining a drug concentration time or location profile based on a drug absorption rate profile and a drug permeability time or location profile. FIG. 5B depicts an example drug permeability time or location profile with the associated time and location information.

FIG. 6 depicts example steps and profiles utilized in obtaining a GI drug requirement amount profile based on a drug concentration time or location profile and a GI liquid volume time or location profile.

FIG. 7 depicts an example cumulative drug release profile.

FIGS. 8A and 8B depict the impact of utilizing techniques to optimize absorption on an example drug concentration time or location profile. FIG. 8A depicts the effect of increasing the solubility of the example drug. FIG. 8B depicts the effect of increasing the permeability of the example drug at different time points after administration and the subsequent impact on concentration profiles.

### DETAILED DESCRIPTION

The present disclosure provides, in some aspects, methods of designing an oral drug dosage form formulated and configured to provide a target pharmacokinetic (PK) profile for a drug in an individual. The disclosure of the present application is based, at least in part, on the inventors' findings and unique perspectives regarding approaches for designing oral drug dosage forms to provide a desired target PK profile based on physiologically-based gastrointestinal (GI) model simulation. Using the methods described herein, the amount of drug to be released in specific GI tract sections can be accurately calculated based on the associated drug absorption in each GI tract section so that the oral drug dosage form can be precisely designed to achieve a desired effect, as measured by a target PK profile, using an optimal total drug amount in the oral drug dosage form. The methods disclosed herein enable 3 critical R's for the design of an oral drug dosage form capable of obtaining a desired target PK profile by precision drug release -right amount, right time, and right location. Such methods provide significant advancements in the field of oral drug dosage form design and enable, e.g., accurate, adjustable, and rapid formulation design. Amongst other advantages, the design methods described herein are applicable to drugs belonging to any Biopharmaceutical Classification System (BCS) drug class as the methods address the interplay between GI location-dependent solubility and permeability, and allow for optimization of drug absorption based on modifications of drug solubility and/or permeability. In contrast, the usefulness of known in vitro in vivo correlation (IVIVC) techniques is extremely limited to BCS Class II drugs. The ability to design an oral drug dosage form by determining the required drug release profile further enables rapid production of oral drug dosage forms capable of providing a desired target PK profile using techniques capable of producing precision drug release, such as three-dimensional (3D) printing of oral drug dosage forms. This innovative approach provides, e.g., means for preclinical and clinical trial formulation development on a predictable and accelerated timeline.

Thus, in some aspects, provided herein is a method of designing an oral drug dosage form formulated and configured to provide a target pharmacokinetic (PK) profile for a drug in an individual, the method comprising: (a) determining a simulated drug release profile configured to obtain the target PK profile, wherein the simulated drug release profile comprises an amount of the drug released from the oral drug dosage form at a plurality of time points over a pre-determined time course, and wherein each time point of the simulated drug release profile is determined based on an amount of the drug absorbed at the time point, a permeability value for the drug in a location of the gastrointestinal (GI) tract associated with the time point, and a liquid volume of the GI tract at a location associated with the time point; and (b) designing the oral drug dosage form to release the drug based on the simulated drug release profile thereby designing the oral drug dosage form formulated and configured to provide the target PK profile.

In other aspects, provided herein is a method of designing an oral drug dosage form formulated and configured to provide a target pharmacokinetic (PK) profile for a drug in an individual, the method comprising: (a) determining a drug absorption rate profile based on mathematical deconvolution of a target PK profile using a disposition profile of the drug, and a total amount of the drug in the oral drug dosage form; (b) determining a drug absorption amount profile based on the drug absorption rate profile; (c) determining a drug concentration time or location profile based on the drug absorption rate profile and a permeability time or location profile for the drug, (d) determining a GI drug requirement amount profile based on the drug concentration time or location profile and a GI liquid volume time or location profile; (e) determining a simulated drug release profile configured to obtain the target PK profile based on the drug absorption amount profile and the GI drug requirement amount profile, wherein the simulated drug release profile comprises an amount of the drug released from the oral drug dosage form to obtain the target PK profile; and (f) designing the oral drug dosage form to release the drug based on the simulated drug release profile thereby designing the oral drug dosage form formulated and configured to provide the target PK profile.

In other aspects, provided herein is an oral drug dosage form comprising a drug formulated and configured to have a target pharmacokinetic (PK) profile, wherein the oral drug dosage form is formulated and configured to release the drug based on a design obtained from any design method taught herein.

In other aspects, provided herein is an oral drug dosage form comprising a drug formulated and configured to have a target pharmacokinetic (PK) profile, wherein the oral drug dosage form is formulated and configured to release the drug based on a simulated drug release profile designed to obtain the target PK profile.

In other aspects, provided herein is a method of making an oral drug dosage form comprising a drug formulated and configured to have a target pharmacokinetic (PK) profile, the method comprising three-dimensional (3D) printing the oral drug dosage form based on a design of the oral drug dosage form obtained from any design method described herein.

In other aspects, provided herein is a method of making an oral drug dosage form comprising a drug formulated and configured to have a target pharmacokinetic (PK) profile, the method comprising three-dimensional (3D) printing the oral drug dosage form based on a design of the oral drug dosage form obtained from a method comprising: (a) determining a drug absorption rate profile based on deconvolution of a target PK profile using a disposition profile of a drug, and a total amount of the drug in the oral drug dosage form; (b) determining a drug absorption amount profile based on the drug absorption rate profile; (c) determining a drug concentration time or location profile based on the drug absorption rate profile and a permeability time or location profile for the drug, (d) determining a GI drug requirement amount profile based on the drug concentration time or location profile and a GI liquid volume time or location profile; (e) determining a simulated drug release profile configured to obtain the target PK profile based on the drug absorption amount profile and the GI drug requirement amount profile, wherein the simulated drug release profile comprises an amount of the drug released from the oral drug dosage form to obtain the target PK profile; and (f) designing the oral drug dosage form to release the drug based on the simulated drug release profile thereby designing the oral drug dosage form formulated and configured to provide the target PK profile.

Although much of the application discusses oral drug dosage forms comprising a drug, one of ordinary skill in the art will readily understand that this disclosure also applies and pertains to other oral dosage forms configured and formulated to provide a desired PK profile of any compound, such as a dosage form comprising a reagent (e.g., an oral reagent dosage form).

It will also be understood by those skilled in the art that changes in the form and details of the implementations described herein may be made without departing from the scope of this disclosure. In addition, although various advantages, aspects, and objects have been described with reference to various implementations, the scope of this disclosure should not be limited by reference to such advantages, aspects, and objects.

### I. Definitions

For purposes of interpreting this specification, the following definitions will apply and whenever appropriate, terms used in the singular will also include the plural and vice versa. In the event that any definition set forth below conflicts with any document incorporated herein by reference, the definition set forth shall control.

As used herein, the term “individual” refers to a mammal and includes, but is not limited to, human, bovine, horse, feline, canine, rodent, rat, mouse, dog, or primate. In some embodiments, the individual is human.

The terms “comprising,” “having,” “containing,” and “including,” and other similar forms, and grammatical equivalents thereof, as used herein, are intended to be equivalent in meaning and to be open ended in that an item or items following any one of these words is not meant to be an exhaustive listing of such item or items, or meant to be limited to only the listed item or items. For example, an article “comprising” components A, B, and C can consist of (i.e., contain only) components A, B, and C, or can contain not only components A, B, and C but also one or more other components. As such, it is intended and understood that “comprises” and similar forms thereof, and grammatical equivalents thereof, include disclosure of embodiments of “consisting essentially of” or “consisting of.”

Where a range of values is provided, it is understood that each intervening value, to the tenth of the unit of the lower limit, unless the context clearly dictate otherwise, between the upper and lower limit of that range and any other stated or intervening value in that stated range, is encompassed within the disclosure, subject to any specifically excluded limit in the stated range. Where the stated range includes one or both of the limits, ranges excluding either or both of those included limits are also included in the disclosure.

Reference to “about” a value or parameter herein includes (and describes) variations that are directed to that value or parameter per se. For example, description referring to “about X” includes description of “X.”

As used herein, including in the appended claims, the singular forms “a,” “or,” and “the” include plural referents unless the context clearly dictates otherwise.

### II. Methods of Designing an Oral Drug Dosage Form

The present disclosure provides, in some aspects, methods of designing an oral drug dosage form formulated and configured to provide a target pharmacokinetic (PK) profile for a drug in an individual. The methods provided herein, in some aspects, enable the design of oral drug dosage forms based on a target PK profile, such as designed to be bioequivalent to a reference dosing regimen, and additional information including drug disposition, drug permeability, and the volume of liquid in locations of the gastrointestinal (GI) tract. In some embodiments, the additional information, including drug disposition, drug permeability, and the volume of liquid in a location of the GI tract are known, such as based on literature values.

When an oral drug dosage form is administered orally, the drug is released from the oral drug dosage form as the oral drug dosage form resides and travels through the GI tract. After release, a portion of the amount of the drug released is absorbed, and the remaining portion of the amount of the drug released passes downstream as the drug travels down the GI tract. As the oral drug dosage form travels down the GI tract, the amount of newly released drug and the drug that was not absorbed at an upstream position may be used to determine a total amount of the drug at a downstream position in the GI tract available for absorption from the oral drug dosage form. As described herein, the rate of drug absorption is positively related to the concentration of the drug in the GI tract (which is based on an amount of the drug at a position in the GI tract and an associated liquid volume of the GI tract) and the permeability of the drug. As also described herein, the absorption of the drug in the GI tract can be represented by a drug absorption rate profile. After the drug is absorbed, biological processes act on the drug in the body, such as via drug distribution, metabolism, and excretion. Generally, these biological processes are consistent with those to which the drug is subjected to in the body after intravenous injection. The amount of drug that remains in circulation may be represented by a pharmacokinetic (PK) curve. The methods described herein take all these processes, including specific parameters involved during the processes, into consideration, and enables the use of a PK curve to determine an amount of a drug that needs to be released from an oral drug dosage form over time as the oral drug dosage form travels through the GI tract.

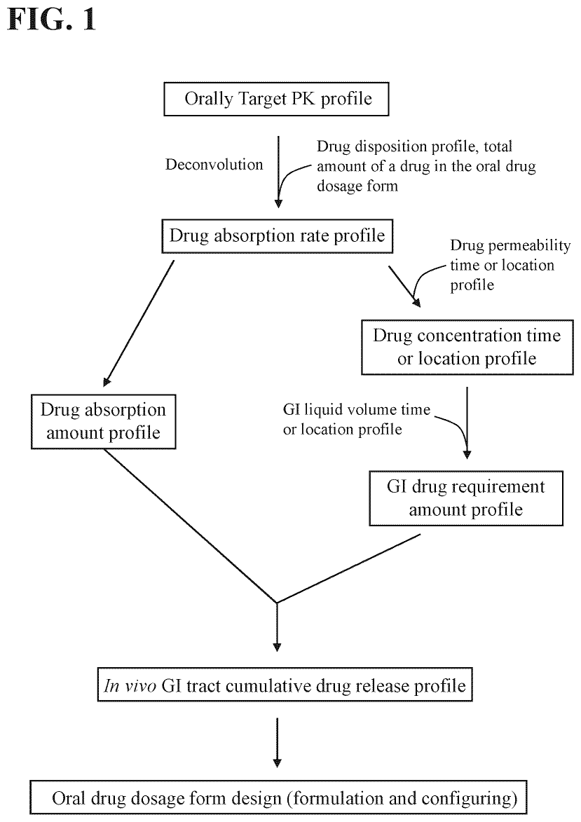

FIG. 1 illustrates an example workflow for designing an oral drug dosage form formulated and configured to provide a target pharmacokinetic (PK) profile as described herein. Briefly, in some embodiments, a target profile is processed using mathematical deconvolution of the disposition profile of a drug, and the total amount of the drug in an oral drug dosage form to determine a simulated drug release absorption rate profile. The simulated drug release absorption rate profile is then used in calculations carried out in two parallel tracks to determine a simulated drug release profile. Specifically, one track involves determining a drug absorption amount profile based on the drug absorption rate profile. The parallel track involves utilizing the drug absorption rate profile and the drug permeability time or location profile to first determine a drug concentration time or location profile. This drug concentration time or location profile and a GI liquid volume time or location profile is then used to determine a GI drug requirement amount profile (a profile of the amount of drug required and soluble for absorption in the GI tract from the oral drug dosage form). The simulated drug release profile is then determined based on the drug absorption amount profile and the GI drug requirement amount profile. The simulated drug release profile enables the design of oral drug dosage forms formulated and configured to provide a target PK profile.

In some embodiments, the method comprises (a) determining a simulated drug release profile configured to obtain the target PK profile, wherein the simulated drug release profile comprises an amount of the drug released from the oral drug dosage form at a plurality of time points over a pre-determined time course, and wherein each time point of the simulated drug release profile is determined based on an amount of the drug absorbed at the time point, a permeability value for the drug in a location of the gastrointestinal (GI) tract associated with the time point, and a liquid volume of the GI tract at a location associated with the time point; and (b) designing the oral drug dosage form to release the drug based on the simulated drug release profile thereby designing the oral drug dosage form formulated and configured to provide the target PK profile.

In some embodiments, provided is a method of designing an oral drug dosage form formulated and configured to provide a target pharmacokinetic (PK) profile for a drug in an individual, the method comprising: (a) determining a drug absorption rate profile based on deconvolution of a target PK profile using a disposition profile of the drug, and a total amount of the drug in the oral drug dosage form; (b) determining a drug absorption amount profile based on the drug absorption rate profile; (c) determining a drug concentration time or location profile based on the drug absorption rate profile and a permeability time or location profile for the drug, (d) determining a GI drug requirement amount profile based on the drug concentration time or location profile and a GI liquid volume time or location profile; (e) determining a simulated drug release profile configured to obtain the target PK profile based on the drug absorption amount profile and the GI drug requirement amount profile, wherein the simulated drug release profile comprises an amount of the drug released from the oral drug dosage form to obtain the target PK profile; and (f) designing the oral drug dosage form to release the drug based on the simulated drug release profile thereby designing the oral drug dosage form formulated and configured to provide the target PK profile. In some embodiments, determining a drug absorption rate profile comprises deconvoluting the target PK profile with the disposition profile of a drug. In some embodiments, the method further comprises determining a cumulative drug release profile based on the simulated drug release profile.

In certain aspects of the features described herein, a relationship exists between the location of an oral drug dosage form and a time, such as determined post administration of the oral drug dosage form. In some embodiments, a feature of the invention, such as a profile, e.g., a drug concentration time or location profile, may be described in terms of either time or location, or both based on the relationship between the time and location of the oral drug dosage form as it travels through the GI tract. In some embodiments, description provided herein is directed to one of time or location, and is not intended to exclude that the described relationship between time and location can be used to convert a time-based feature into a location-based feature and vice versa. For example, in some embodiments, the methods use a drug permeability time or location profile based on time. In some embodiments, the methods use a drug permeability time or location profile based on location. In some embodiments, the methods use a drug permeability time or location profile based on time and location.

In certain aspects, features of the invention are described as a profile. In some embodiments, the profile comprises one or more data points based on time and/or location. For example, a simulated drug release profile contains information regarding the amount of drug released from an oral drug dosage form and may be based on time (such as measured post administration) and/or location. Unless otherwise stated, description of a feature of the invention via a profile or a data point is not intended to be limited to only that manner of characterization. As described herein, in some embodiments, a time point can be used as a proxy for a GI location, and vice versa, based on the correlation time and location as a function of the time course of an oral drug dosage form traveling through the GI tract following administration (time zero). In some embodiments, a profile comprises data points based on time, wherein the time points occur in intervals, such as regular one hour intervals. When data points are based on time, the time interval can be any desired time interval. In some embodiments, a profile comprises data points based on location, e.g., such as location based on anatomical sections of the GI tract such as the stomach, duodenum, jejunum, ileum, ascending colon, transverse colon, descending colon, sigmoid colon, and rectum. Accordingly, in the description provided herein discussion of time points (and profiles thereof) encompasses, or can be extended to, time and/or location information, and discussion of location points (and profiles thereof) encompasses, or can be extended to, time and/or location information.

Certain features of the methods are described in additional detail in the sections below, including steps to determine a simulated drug release profile configured to obtain a target PK profile. The modular discussion of such features is not intended to limit the scope of the methods described herein, and using the teachings provided herein one can readily combine various modularly described features to arrive at the full scope of the methods provided herein.

### A. Target PK Profiles

In some aspects, the method comprises obtaining, such as determining, a target PK profile. Target PK profiles comprise the plasma concentration of a drug over time, such as post administration of an oral drug dosage form. In some embodiments, the target PK profile may be based on any desired drug plasma concentration in an individual as a function of time, such as to improve efficacy, safety, and ease of administration. For example, in some embodiments, the target PK profile is based on a desired efficacy of the associated drug, e.g., an efficacy-based target PK profile. Target PK profiles may be for any pre-determined amount of time. For example, in some embodiments, the target PK profile is for a time period of between about 6 hours and 1 week. In some embodiments the target PK profile is for about a 24-hour period of time.

In some embodiments, the target PK profile is designed based on a reference dosing regimen. In some embodiments, the target PK profile is bioequivalent to a reference PK profile of a reference dosing regimen. In some embodiments, bioequivalence is based on the regulatory definition of bioequivalence, such as established by the United States Food and Drug Administration (FDA). In some embodiments, the target PK profile is based on a reference PK profile, wherein one or more features of the target PK profile, such as AUC or Cmax, are adjusted to a desired level (such as a percentage decrease or increase as compared to a reference PK profile). Techniques for measuring a PK curve of a drug, such as a reference PK profile, are known in the art. See, e.g., Heller et al., Annu Rev Anal Chem, 11, 2018; and Ghandforoush-Sattari et al., J Amino Acids, Article ID 346237, Volume 2010.

In some embodiments, the target PK profile has at least a 90% confidence interval that falls within the range of about 80% to about 125% for a ratio of the AUCo- for a dosing regimen of the oral drug dosage form and a reference dosing regimen, where/is based on the pre-determined time course.

In some embodiments, the target PK profile has at least a 90% confidence interval that falls within the range of about 80% to about 125% for the relative mean of a ratio of the AUCost for a dosing regimen of the oral drug dosage form and a reference dosing regimen, where t is based on the pre-determined time course.

In some embodiments, the target PK profile has at least a 90% confidence interval that falls within the range of about 80% to about 125% for a ratio of the Cₘₐₓ for a dosing regimen of the oral drug dosage form and a reference dosing regimen.

In some embodiments, the target PK profile has at least a 90% confidence interval that falls within the range of about 80% to about 125% for the relative mean of a ratio of the Cₘₐₓ for a dosing regimen of the oral drug dosage form and a reference dosing regimen.

In some embodiments, the target PK profile has at least a 90% confidence interval that falls within the range of about 80% to about 125% for a ratio of the Cₜ for a dosing regimen of the oral drug dosage form and a reference dosing regimen, where/is based on the pre-determined time course.

In some embodiments, the target PK profile has at least a 90% confidence interval that falls within the range of about 80% to about 125% for the relative mean of a ratio of the Cₜ for a dosing regimen of the oral drug dosage form and a reference dosing regimen, where/is based on the pre-determined time course.

In some embodiments, the target PK profile has at least a 90% confidence interval that falls within the range of about 80% to about 125% for a ratio of the C₂₄ₕ for a dosing regimen of the oral drug dosage form and a reference dosing regimen, where 24 h is 24 hours post dose.

In some embodiments, the target PK profile has at least a 90% confidence interval that falls within the range of about 80% to about 125% for the relative mean of a ratio of the C₂₄ₕ for a dosing regimen of the oral drug dosage form and a reference dosing regimen, where 24 h is 24 hours post dose.

In some embodiments, the target PK profile has at least a 90% confidence interval that falls within the range of about 80% to about 125% for a ratio of the AUC_{0-∞} for a dosing regimen of the oral drug dosage form and a reference dosing regimen.

In some embodiments, the target PK profile has at least a 90% confidence interval that falls within the range of about 80% to about 125% for the relative mean of a ratio of the AUC_{0-∞} for a dosing regimen of the oral drug dosage form and a reference dosing regimen.

In some embodiments, the target PK profile has an AUC₀₋ₜ, Cₘₐₓ, and Cₜ, within an acceptable threshold of a reference PK profile of a reference dosing regimen, where/is based on the pre-determined time course.

### B. Drug Absorption Rate Profiles

In some aspects, the method comprises obtaining, such as determining, a drug absorption rate profile configured to obtain a target PK profile. In some embodiments, drug absorption rate profiles comprise an uptake rate of a drug over time, e.g., post administration of an oral drug dosage form, such that the target PK profile is obtained. Drug absorption rate profiles may be for any pre-determined amount of time. In some embodiments, the length of time of a simulated drug absorption rate profile is based on, such as matches, the length of time of a target PK profile.

In some embodiments, the drug absorption rate profile is based on deconvolution of the target PK profile with a disposition profile of the drug according to Equation I:

$${q}_{abs} ( t ) = {L}^{- 1} [ \frac{L \{ {C}_{p , oral} ( t ) \}}{L \{ {C}_{p , disposition} ( t ) \}} ] ,$$

Equation I, where L and L⁻¹ are Laplace transform and inverse Laplace transform, where q_{abs}(t)is based on the drug absorption rate profile as a function of time, and where C_{p,oral}(t) and C_{p,disposition}(t) are based on the plasma level concentration profile as a function of time of oral administration and disposition, respectively.

In some embodiments, the drug absorption rate profile is based on deconvolution of a target PK profile utilizing a disposition profile of a drug and a total amount of the drug in an oral drug dosage form.

In some embodiments, the disposition profile of a drug comprises the plasma concentration of the drug over time. In some embodiments, the disposition profile of a drug reflects the fate of the drug after absorption from the GI tract. For example, in some embodiments, the disposition profile of a drug reflects the amount of the drug remaining in the plasma as a function of biological processes such as distribution, metabolism, and excretion. In some embodiments, the disposition profile of a drug comprises the plasma concentration of the drug as measured over time when the drug is administered via a parenteral route. In some embodiments, the disposition profile of a drug comprises the plasma concentration of the drug at a plurality of time points when the drug is administered via a parenteral route. In some embodiments, the parenteral route is intravenous bolus (IV) administration. In some embodiments, the disposition profile of a drug is a known profile. In some embodiments, the method further comprises obtaining the disposition profile of a drug, such as after IV administration of the drug followed by measuring the plasma concentration of the drug over time.

In some embodiments, the disposition profile of a drug is obtained following parenteral administration (such as IV administration) of an amount of the drug, wherein the amount of the drug in the IV formulation is based on the amount of the drug that would be absorbed from the GI tract if the drug were administered orally. For example, the known bioavailability of an orally administered drug may be used to assess the amount of the drug that will be absorbed from an orally administered dosage form comprising a fixed amount of the drug, such that the amount of the drug administered parenterally will closely simulate amount of drug absorbed from administration of the oral drug dosage form. In some embodiments, the amount of a drug in an IV formulation is bioequivalent to the amount of the drug in an orally administered drug dosage form.

In some embodiments, the method further comprises performing a deconvolution of a target PK profile with a disposition profile the drug. Techniques for deconvolution are known in the art, and include the Wagner-Nelson method, numerical methods, and mathematical deconvolution.

### C. Drug Absorption Amount Profiles

In some aspects, the method comprises obtaining, such as determining, a drug absorption amount profile. In some embodiments, drug absorption amount profiles comprise an amount of drug absorbed from the oral drug dosage form over time. Drug absorption amount profiles may be for any pre-determined amount of time. In some embodiments, the length of time of a drug absorption amount profile is based on, such as matches, the length of time of a target PK profile and/or drug absorption rate profile. In some embodiments, the method comprises obtaining, such as determining, the amount of a drug absorbed from the oral drug dosage form at a time point, such as a time point post administration.

In some embodiments, the amount of a drug absorbed from an oral drug dosage form at a time point is based on a drug absorption rate profile and a time interval. In some embodiments, the amount of a drug absorbed from an oral drug dosage form is based on Equation IV,

Q_{abs}(t)=q_{abs}(t)×Δt, Equation IV,

where Q_{abs}(t) is the amount of the drug absorbed from the oral drug dosage form as a function of time, and where q_{abs}(t) is the absorption rate of the drug as a function of time. As described herein, the time interval may be selected based on a desired time interval. In some embodiments, the time interval is an hour.

### D. Drug Concentration Time or Location Profiles and GI Drug Requirement Amount Profiles

In some aspects, the method comprises obtaining, such as a determining, an amount of a drug required for absorption from an oral drug dosage form at a time point and/or location of the GI tract. In some embodiments, the amount of drug required for absorption from the oral drug dosage form at the time point and/or location isbased on permeability value for the drug at the expected location of the drug within the GI tract at the time point or location, and the liquid volume of the GI tract associated with the time point or location. As described herein, a relationship exists between time and location for an oral drug dosage form in the GI tract, and it is possible to convert information provided based on time as measured post administration and GI tract location.

In some embodiments, determining an amount of a drug required for absorption from an oral drug dosage form at a time point and/or location of the GI tract comprises use of a drug concentration time or location profile. As described herein, the amount of drug required for absorption from an oral drug dosage form at a time point and/or location is based on the portion of the amount of the drug released from the oral drug dosage form upstream and not absorbed and the amount of newly released drug from the oral drug dosage form. In some aspects, the method comprises obtaining, such as determining, a drug concentration time or location profile. Drug concentration time or location profiles comprise concentrations of a drug in the GI tract from an oral drug dosage form over time and/or location necessary to obtain a drug absorption rate profile. In the methods described herein, there exists interplay between the concentration of a drug in a location of the GI tract from an oral drug dosage form and the permeability of the drug at that location. For example, a fixed absorption rate profile may have numerous concentration-permeability combinations. In some embodiments, the drug concentration time or location profile is a selected drug concentration time or location profile, e.g., selected based on an associated permeability. Drug concentration time or location profiles may be for any pre-determined amount of time. In some embodiments, the length of time of a drug concentration time or location profile is based on, such as matches, the length of time of a target PK profile and/or drug absorption rate profile and/or drug absorption amount profile. In some embodiments, the drug concentration time or location profile includes drug concentration information based on time post administration or drug concentration information based on location in the GI tract. In some embodiments, the drug concentration time or location profile includes concentration information based on time and location in the GI tract.

In some embodiments, the drug concentration time or location profile is based on the drug absorption rate profile and a drug permeability time or location profile. In some embodiments, the drug permeability time or location profile comprises the permeability value for the drug in a location of the (GI) tract such as at an associated time point. In some embodiments, the drug concentration or location profile is based on Equation II,

q_{abs}(t/x)=C(t/x)×P(t/x), Equation II,

where C(t/x) is the concentration of the drug soluble for absorption from the oral drug dosage form as a function of time or location, where q_{abs}(t/x) is the absorption rate of the drug as a function of time or location, and where P(t/x) is the permeability of the drug as a function of time or location. As noted in Equation II, adjusting the permeability of the drug will impact the concentration of the drug required to achieve the desired absorption rate, and vice versa, resulting in numerous concentration-permeability combinations. Thus, in some embodiments, the method described herein comprise use of a selected concentration-permeability combination.

In some embodiments, the drug permeability time or location profile is a known profile, such as based on a known literature profile. In some embodiments, the method further comprises obtaining the drug permeability time or location profile, such as via a GI tract regional drug absorption study. In some embodiments, the permeability value of a drug permeability time or location profile accounts for the intestinal surface area of a location of the GI tract associated with the permeability value.

In some aspects, the method comprises obtaining, such as determining, an amount of a drug required for absorption in a location of the GI tract from an oral drug dosage form and/or at a time based on a drug concentration time or location profile. In some embodiments, the amount of a drug required for absorption in a location of the GI tract from the oral drug dosage form, such as at a time point, is based on a drug concentration time or location profile and a GI liquid volume time or location profile. In some embodiments, the amount of a drug required for absorption in a location of the GI tract and/or at a time post administration is represented via a GI drug requirement amount profile. In some embodiments, the GI drug requirement amount profile, or the amount of a drug required for absorption in a location of the GI tract and/or at a time from an oral drug dosage form is based on Equation III,

Q_{GIT}(t/x)=C_{GIT}(t/x)×V_{GIT}(t/x), Equation III,

where Q_{GIT}(t/x) is the amount of the drug required for absorption from the oral drug dosage form as a function of the time point or location, where C_{GIT}(t/x) is the concentration of the drug soluble in GI tract from the oral drug dosage form as a function of the time point or location, and where V_{GIT}(t/x) is the liquid volume of the GI tract as a function of the time point or location.

In some embodiments, the GI liquid volume time or location profile is a known profile. In some embodiments, the method comprises obtaining the GI liquid volume time or location profile. In some embodiments, the GI liquid volume time or location profile reflects a condition or state of an individual. For example, in some embodiments, the GI liquid volume time or location profile can reflect the food condition, such as either a fed or fasting state of the individual when administering an oral drug dosage form.

### E. Simulated Drug Release Profiles and Cumulative Drug Release Profiles

In some aspects, the method comprises obtaining, such as determining, a simulated drug release profile and/or a simulated cumulative drug release profile. Simulated drug release profiles and simulated cumulative drug release profiles are based on the amount of a drug released from an oral drug dosage form over time, which as described herein, can also be linked to location in the GI tract. Specifically, in some embodiments, the simulated drug release profile is based on the amount of a drug released from an oral drug dosage form at a time point, and the simulated cumulative drug release profile is based on the cumulative amount of drug released from the oral drug dosage form at a time point.

In some embodiments, the simulated drug release profile is determined based on the drug absorption amount profile and the GI drug requirement amount profile. In some embodiments, the simulated drug release profile is determined using Equation V. Equation V is:

Q_{GI release}(tᵢ/xᵢ)=[Q_{GIT}(tᵢ/xᵢ)+Q_{abs}(tᵢ)]−[Q_{GIT}(tᵢ₋₁/xᵢ₋₁)−Q_{abs}(tᵢ₋₁)], Equation V,

where Q_{GI release}(tᵢ/xᵢ) is the amount of the drug released from the oral drug dosage form at a time of tᵢ or GI tract location of xᵢ, where Q_{GIT}(tᵢ/xᵢ) is the amount of drug required for absorption in the GI tract from the oral drug dosage form at a time of tᵢ or GI tract location of xᵢ, where Q_{GIT}(tᵢ₋₁/xᵢ₋₁) is the amount of drug required for absorption in the GI tract from the oral drug dosage form at a time of tᵢ₋₁ or GI tract location of xᵢ₋₁ and where Q_{abs}(tᵢ) is the amount of the drug absorbed from the oral drug dosage form at a time of tᵢ, and Q_{abs}(tᵢ₋₁) is the amount of the drug absorbed from the oral drug dosage form at a time of tᵢ₋₁.

In some embodiments, the simulated cumulative drug release profile is determined using Equation VI. Equation VI is:

Q_{GI cumulative release}(t)=Σ₀^{t}[Q_{Gi release}(t)×Δt], Equation VI,

where Q_{GI cumulative release}(t) is the amount of the cumulative drug released from the oral drug dosage form as a function of time, and where Q_{Gi release}(t) is the amount of the drug released from the oral drug dosage form as a function of time.

In some embodiments, the simulated cumulative drug release profile is determined using Equation VII. Equation VII is:

Q_{GI cumuatlive release}(t)=∫₀^{t}Q_{Gi release}(t)dt, Equation VII.

### F. Methods for Optimizing Absorption

In certain aspects, provided herein are techniques for optimizing absorption that are useful in conjunction with the design methods and oral drug dosage forms described herein. In some embodiments, the optimization technique comprises modulating permeability of a drug. In some embodiments, the optimization technique comprises modulating drug solubility. In some embodiments, the optimization technique comprises modulating the release of the drug based on time and/or location in the GI tract.

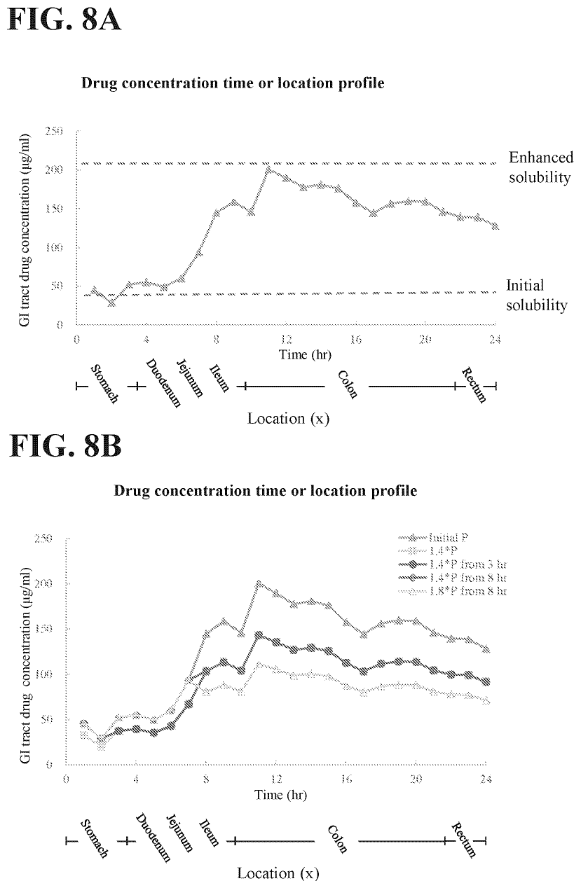

In some embodiments, the drug concentration time or location profile indicates concentrations of the drug in the GI tract required to achieve the target PK profile exceed the solubility of the drug, such as based on data obtained from artificially simulated conditions using gastric juice, intestinal juice, or colon juice. See, FIG. 8A. In some embodiments, when the concentrations of the drug in the GI tract required to achieve the desired absorption rate profile exceed the solubility of the drug, the drug solubility can be modulated, such as increased. In some embodiments, the drug solubility is modulated, such as increased, by using different forms and/or preparations of the drug, e.g., an amorphous solid dispersion (ASD) of the drug. In some embodiments, the drug solubility is modulated, such as increased, by using a solubility enhancer, such as an excipient. In some embodiments, the solubility enhancer is contained in the oral drug dosage form. In some embodiments, the solubility enhancer is released from the oral drug dosage form in a controlled manner (e.g., controlled amount in a controlled location).

In some embodiments, the drug concentration time or location profile can be modulated to account for indicated in congruencies between the concentration of the drug required in the GI tract to achieve the target PK profile and the solubility of the drug. In some embodiments, the permeability of a drug is also modulated to adjust the absorption rate, with or without adjusting the drug concentration. As described herein, in the provided methods there exists an interplay between the concentration of a drug in a location of the GI tract from an oral drug dosage form and the permeability of the drug at that location. In some embodiments, the permeability of the drug can be enhanced to modulate the drug concentration time or location profile. In some embodiments, the permeability of the drug is modulated by inhibiting an efflux pump, such as by using an efflux pump inhibitor (e.g., a P-gp inhibitor), to enhance the drug permeability. In some embodiments, the permeability of the drug is modulated by enhancing drug penetration, such as using a permeability enhancer to enhance the drug permeability. In some embodiments, the efflux pump inhibitor and/or permeability enhancer is contained in the oral drug dosage form. In some embodiments, the efflux pump inhibitor and/or permeability enhancer is released from the oral drug dosage form in a controlled manner (e.g., controlled amount in a controlled location).

As shown in FIG. 8B, modulation of drug permeability values can change the drug concentration time or location profile. FIG. 8B depicts the impact on the drug concentration time or location profile when (a) permeability values are changed to 1.4 times the original permeability values from 0 to 24 hours after dosing, (b) permeability values are changed to 1.4 times the original permeability values from 3 (jejunum) to 24 hours after dosing, (c) permeability values are changed to 1.4 times the original permeability values from 8 (colon) to 24 hours after dosing, and (d) permeability values are changed to 1.8 times the original permeability values from 8 (colon) to 24 hours after dosing.

In some embodiments, the oral drug dosage form is optimized to affect the Q_{GIT}(t/x), where Q_{GIT}(t/x) is the amount of the drug required for absorption from the oral drug dosage form as a function of location and/or time. In some embodiments, optimization of the drug released from the oral drug dosage form is based on improving drug permeability and/or drug solubility, and the interplay therebetween, based on when and where the drug is released from the oral drug dosage form.

In some embodiments, more than one optimization method is employed in the methods described herein. For example, in some embodiments, any one or more of drug solubility, permeability, and release are modulated.

In some embodiments, the methods comprise selecting an optimized design of an oral drug dosage form formulated and configured to provide a target PK profile for a drug in an individual.

### G. Example Method of Designing an Oral Drug Dosage Form

In some embodiments, provided is a method of designing an oral drug dosage form formulated and configured to provide a target pharmacokinetic (PK) profile for a drug in an individual, the method comprising: (a) determining a drug absorption rate profile based on deconvolution of a target PK profile using a disposition profile the drug, and a total amount of a drug in the oral drug dosage form; (b) determining a drug absorption amount profile based on the drug absorption rate profile; (c) determining a drug concentration time or location profile based on the simulated drug absorption rate profile and a permeability time or location profile for the drug, (d) determining a GI drug requirement amount profile based on the drug concentration time or location profile and a GI liquid volume time or location profile; (e) determining a simulated drug release profile configured to obtain the target PK profile based on the drug absorption amount profile and the GI drug requirement amount profile, wherein the simulated drug release profile comprises an amount of the drug released from the oral drug dosage form to obtain the target PK profile; and (f) designing the oral drug dosage form to release the drug based on the simulated drug release profile thereby designing the oral drug dosage form formulated and configured to provide the target PK profile. In some embodiments, determining a drug absorption rate profile comprises deconvoluting the target PK profile with the disposition profile of the drug. In some embodiments, the method further comprises determining a cumulative drug release profile based on the simulated drug release profile.

In some embodiments, provided is a method of designing an oral drug dosage form formulated and configured to provide a target pharmacokinetic (PK) profile for a drug in an individual, the method comprising designing the oral drug dosage form to release the drug based on a simulated drug release profile thereby designing the oral drug dosage form formulated and configured to provide the target PK profile. In some embodiments, the method comprises determining a drug absorption rate profile based on deconvolution of a target PK profile using a disposition profile of the drug, and a total amount of a drug in the oral drug dosage form. In some embodiments, the method comprises determining a drug absorption amount profile based on the drug absorption rate profile. In some embodiments, the method comprises determining a drug concentration time or location profile based on the simulated drug absorption rate profile and a permeability time or location profile for the drug. In some embodiments, the method comprises determining a GI drug requirement amount profile based on the drug concentration time or location profile and a GI liquid volume time or location profile. In some embodiments, the method comprises determining a simulated drug release profile configured to obtain the target PK profile based on the drug absorption amount profile and the GI drug requirement amount profile, wherein the simulated drug release profile comprises an amount of the drug released from the oral drug dosage form to obtain the target PK profile. In some embodiments, determining a drug absorption rate profile comprises deconvoluting the target PK profile with the disposition profile of the drug. In some embodiments, the method further comprises determining an estimated drug release profile based on the simulated drug release profile.

In some embodiments, provided is a method of designing an oral drug dosage form formulated and configured to provide a target pharmacokinetic (PK) profile for a drug in an individual, the method comprising: (a) generating a drug absorption rate profile for the drug in the gastrointestinal (GI) based on mathematical deconvolution of the target PK profile to remove therefrom from a disposition profile of the drug (such as a disposition profile based on the PK profile of the drug following intravenous bolus administration of the drug); (b) simulating the drug concentration-permeability interplay as a function of time and/or location to identify drug concentration and permeability combinations that satisfies the drug absorption rate profile, wherein the drug concentration and permeability value combinations are identified as technically feasible or non-ideal, (c) determining a GI drug requirement amount profile based on the drug concentration-permeability interplay simulation and a drug concentration and permeability combinations that satisfies the drug absorption rate profile, a drug concentration time or location profile, and a GI liquid volume time or location profile; and (d) determining a cumulative drug release profile based on the GI drug requirement amount profile, thereby designing an oral drug dosage form formulated and configured to provide the target PK profile for the drug in the individual. In some embodiments, the method further comprises designing a multi-compartment oral drug dosage form to release the drug (and any functional excipients if needed) based on the cumulative drug release profile. In some embodiments, non-ideal drug concentration and permeability value combinations are subjected to an optimization strategy thereby resulting in a drug concentration and permeability combinations that satisfies the drug absorption rate profile. In some embodiments, the optimization strategy comprises modulating (such as increasing) solubility kinetics, modulating (such as enhancing) apparent permeability, or modulating (such as inhibiting) drug degradation, or any combination thereof. In some embodiments, the drug is an ionizable drug, such as a weak acid or weak base at the GI physiological pH range. In some embodiments, for ionizable drugs, the total solubility is that sum of that for ionized and non-ionized species equilibrated by pH-pKa relationship (Henderson-Hasselbalch equation), wherein the non-ionized has a much larger permeability than the ionized species of the drug. In some embodiments, the drug is a non-ionizable drug. In some embodiments, the drug is a non-ionizable drug, wherein the total solubility is based on the non-ionized molecule. In some embodiments, the apparent or net permeability may include negative efflux pump effect. In some embodiments, the use of an efflux inhibitor may increase the apparent permeability. In some embodiments, the method further comprises in vitro testing (such as via a drug release study in biorelevant media, e.g., simulated gastric and/or intestinal fluids) to optimize the oral drug dosage form.

### III. Oral Drug Dosage Forms

In some aspects, provided herein are oral drug dosage forms formulated and configured to have a target pharmacokinetic (PK) profile for a drug. In some embodiments, provided herein is an oral drug dosage form comprising a drug formulated and configured to have a target PK profile, wherein the oral drug dosage form is formulated and configured to release the drug based on a simulated drug release profile to obtain the target PK profile.

In some embodiments, provided is an oral drug dosage form comprising a drug formulated and configured to have a target PK profile, wherein the oral drug dosage form is formulated and configured to release the drug based on a design obtained from any method described herein.

In some embodiments, provided is an oral drug dosage form comprising a drug formulated and configured to have a target PK profile, wherein the oral drug dosage form is formulated and configured to release the drug based on a design obtained from a method comprising (a) determining a drug absorption rate profile based on deconvolution of a target PK profile using a disposition profile of the drug, and a total amount of a drug in the oral drug dosage form; (b) determining a drug absorption amount profile based on the drug absorption rate profile; (c) determining a drug concentration time or location profile based on the drug absorption rate profile and a permeability time or location profile for the drug, (d) determining a GI drug requirement amount profile based on the drug concentration time or location profile and a GI liquid volume time or location profile; (e) determining a simulated drug release profile configured to obtain the target PK profile based on the drug absorption amount profile and the GI drug requirement amount profile, wherein the simulated drug release profile comprises an amount of the drug released from the oral drug dosage form to obtain the target PK profile; and (f) designing the oral drug dosage form to release the drug based on the simulated drug release profile thereby designing the oral drug dosage form formulated and configured to provide the target PK profile.

The oral drug dosage forms provided herein may be any design formulated and configured to release a drug according to a simulated drug release profile configured to obtain a target PK profile. In some embodiments, the oral drug dosage form releases a drug based on diffusion of the drug from a material comprising the drug. In some embodiments, the oral drug dosage form releases a drug based on erosion of an erodible material comprising the drug. In some embodiments, the oral drug dosage form comprises a multi-layered structure comprising a plurality of layers of a first erodible material admixed with the drug. Example erosion-based oral drug dosage forms are described in U.S. Pat. No. 10,350,822, which is hereby incorporated herein by reference in its entirety. In some embodiments, the oral drug dosage form is configured to release a drug from a compartment. In some embodiments, the compartment contents are exposed to the external environment via opening of the compartment and/or breakdown of the compartment. Example compartment-based oral drug dosage forms are described in U.S. Pat Nos. 10,143,626 and 10,363,220 and WO2018137686, which are hereby incorporated herein by reference in their entireties.

Using the disclosure provided herein, oral drug dosage forms can be designed and produced to obtain any target PK curve. In some embodiments, the oral drug dosage form comprises multiple compartments designed to obtain a complex target PK curve. For example, in some embodiments, the multi-compartment oral drug dosage form is configured to release the drug (and any functional excipients if needed) according to a simulated release profile. In some embodiments, the compartment contains a drug. In some embodiments, the compartment contains an excipient, such as a functional excipient. In some embodiments, the compartment contains a drug and an excipient, such as a functional excipient. In some embodiments, each compartment of a multi-compartment oral drug dosage form may release the contents therein, such as a drug, at a desired time following administration and/or at a desired rate. In some embodiments, the compartments of a multi-compartment oral drug dosage form are coordinated to release the contents therein in a coordinated fashion thereby obtaining a target PK profile.

The drug dosage forms of the present invention can be, for example, any size, shape, or weight that is suitable for oral administration to specific individuals, such as a child or an adult. In some embodiments, the selection of size, shape, or weight of the oral drug dosage form is based on an attribute of an individual to which the oral drug dosage form will be administered. In some embodiments, the attribute of the individual is one or more of height, weight, age, or biochemical parameters. In some embodiments, the shape of the oral drug dosage form comprises a cylinder, oval, bullet shape, arrow head shape, triangle, arced triangle, square, arced square, rectangle, arced rectangle, diamond, pentagon, hexagon, octagon, half moon, almond, or a combination thereof. In some embodiments, the size and shape of the oral drug dosage form is suitable for oral administration to the individual.

In some embodiments, the oral drug dosage form has a cross-sectional dimension, such as measured across an exterior surface of the oral drug dosage form (e.g., the largest cross-sectional dimension across a surface of the oral drug dosage form), that is less than about 22 mm, such as less than about any of 21 mm, 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, 4 mm, 3 mm, 2 mm, or 1 mm. In some embodiments, the drug dosage form has a cross-sectional dimension, such as measured across an exterior surface of the oral drug dosage form (e.g., the largest cross-sectional dimension across a surface of the oral drug dosage form), that is about 1 mm to about 22 mm, such as about any of 21 mm, 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, 4 mm, 3 mm, or 2 mm.

In some embodiments, the oral drug dosage form has a thickness of about 1 mm to about 25 mm, such as any of about 2 mm to about 10 mm, about 5 mm to about 12 mm, about 8 mm to about 15 mm, about 5 mm to about 10 mm, or about 7 mm to about 9 mm. In some embodiments, the dosage unit has a thickness of less than about 25 mm, such as less than about any of 24 mm, 23 mm, 22 mm, 21 mm, 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, 4 mm, 3 mm, 2 mm, or 1 mm. In some embodiments, the oral drug dosage form has a thickness of greater than about 1 mm, such as greater than about any of 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, or 25 mm. In some embodiments, the oral drug dosage form has a thickness of about any of 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, or 25 mm.

In some embodiments, the oral drug dosage form comprises a fixed amount of a drug of between about 2000 mg to about 0.01 mg. In some embodiments, the oral drug dosage form comprises a fixed amount of a drug of less than about 2000 mg, such as less than about any of 1900 mg, 1800 mg, 1700 mg, 1600 mg, 1500 mg, 1400 mg, 1300 mg, 1200 mg, 1100 mg, 1000 mg, 900 mg, 800 mg, 700 mg, 600 mg, 500 mg, 450 mg, 400 mg, 350 mg, 300 mg, 250 mg, 200 mg, 150 mg, 100 mg, 75 mg, 50 mg, 45 mg, 40 mg, 35 mg, 30 mg, 25 mg, 20 mg, 15 mg, 10 mg, 5 mg, 4 mg, 3 mg, 2 mg, 1 mg, 0.75 mg, 0.5 mg, 0.25 mg, or 0.1 mg. In some embodiments, the oral drug dosage form comprises a fixed amount of a drug of about any of 2000 mg, 1900 mg, 1800 mg, 1700 mg, 1600 mg, 1500 mg, 1400 mg, 1300 mg, 1200 mg, 1100 mg, 1000 mg, 900 mg, 800 mg, 700 mg, 600 mg, 500 mg, 450 mg, 400 mg, 350 mg, 300 mg, 250 mg, 200 mg, 150 mg, 100 mg, 75 mg, 50 mg, 45 mg, 40 mg, 35 mg, 30 mg, 25 mg, 20 mg, 15 mg, 10 mg, 5 mg, 4 mg, 3 mg, 2 mg, 1 mg, 0.75 mg, 0.5 mg, 0.25 mg, or 0.1 mg.

In some embodiments, the oral drug dosage form has a total weight of about 50 mg to about 2500 mg, such as about any of about 50 mg to about 150 mg, about 150 mg to about 250 mg, about 250 mg to about 350 mg, about 350 mg to about 450 mg, about 450 mg to about 550 mg, about 550 mg to about 650 mg, about 650 mg to about 750 mg, about 750 mg to about 850 mg, about 850 mg to about 950 mg, about 950 mg to about 1050 mg, about 1050 mg to about 1150 mg, about 1150 mg to about 1250 mg, about 1250 mg to about 1350 mg, about 1350 mg to about 1450 mg, about 1450 mg to about 1550 mg, about 1550 mg to about 1650 mg, about 1650 mg to about 1750 mg, about 1750 mg to about 1850 mg, about 1850 mg to about 1950 mg, about 1950 mg to about 2050 mg, about 2050 mg to about 2150 mg, about 2150 mg to about 2250 mg, about 2250 mg to about 2350 mg, or about 2350 mg to about 2450 mg. In some embodiments, the oral drug dosage form has a total weight of at least about 50 mg, such as at least about any of 100 mg, 150 mg, 200 mg, 250 mg, 300 mg, 350 mg, 400 mg, 450 mg, 500 mg, 550 mg, 600 mg, 650 mg, 700 mg, 750 mg, 800 mg, 850 mg, 900 mg, 950 mg, 1000 mg, 1100 mg, 1200 mg, 1300 mg, 1400 mg, 1500 mg, 1600 mg, 1700 mg, 1800 mg, 1900 mg, 2000 mg, 2100 mg, 2200 mg, 2300 mg, 2400 mg, or 2500 mg. In some embodiments, the oral drug dosage form has a total weight of less than about 2500 mg, such as less than about any of 2400 mg, 2300 mg, 2200 mg, 2100 mg, 2000 mg, 1900 mg, 1800 mg, 1700 mg, 1600 mg, 1500 mg, 1400 mg, 1300 mg, 1200 mg, 1100 mg, 1000 mg, 950 mg, 900 mg, 850 mg, 800 mg, 750 mg, 700 mg, 650 mg, 600 mg, 550 mg, 500 mg, 450 mg, 400 mg, 350 mg, 300 mg, 250 mg, 200 mg, 150 mg, 100 mg, or 50 mg.

In some embodiments, the oral drug dosage form comprises more than one drug. In some embodiments, when the oral drug dosage form comprises more than one drug, the oral drug dosage form is formulated and configured to provide a target PK profile for each drug.

In some embodiments, the oral drug dosage form further comprises another agent, such as any one or more of a solubility enhancer, permeability enhancer, an efflux pump inhibitor, or an agent that stabilizes a drug in the GI tract. In some embodiments, the oral drug dosage form is configured and formulated to controllably release another agent (such as in a controlled amount and controlled location). In some embodiments, the other agent is admixed with a drug of an oral drug dosage form. In some embodiments, the other agent is contained separately from a drug of an oral drug dosage form, such as in a separate compartment.

### IV. Methods of Producing an Oral Drug Dosage Form

In some aspects, the present disclosure provides methods of producing, such as three-dimensional (3D) printing, an oral drug dosage form designed using the methods described herein. In some embodiments, the oral drug dosage form is formulated and configured to release a drug based on a simulated drug release profile designed to obtain the target PK profile.

In some embodiments, provided is a method of producing an oral drug dosage form, the method comprising printing the oral drug dosage form, wherein the oral drug dosage form is designed to provide a target pharmacokinetic (PK) profile for a drug in an individual, the design method comprising: (a) determining a simulated drug release profile configured to obtain the target PK profile, wherein the simulated drug release profile comprises an amount of the drug released from the oral drug dosage form at a plurality of time points over a pre-determined time course, and wherein each time point of the simulated drug release profile is determined based on an amount of the drug absorbed at the time point, a permeability value for the drug in a location of the gastrointestinal (GI) tract associated with the time point, and a liquid volume of the GI tract at a location associated with the time point; and (b) designing the oral drug dosage form to release the drug based on the simulated drug release profile thereby designing the oral drug dosage form formulated and configured to provide the target PK profile.

In some embodiments, provided is a method of producing an oral drug dosage form configured and formulated to provide a target PK profile for a drug in an individual, the method comprising (a) determining a simulated drug release profile configured to obtain the target PK profile, wherein the simulated drug release profile comprises an amount of the drug released from the oral drug dosage form at a plurality of time points over a pre-determined time course, and wherein each time point of the simulated drug release profile is determined based on an amount of the drug absorbed at the time point, a permeability value for the drug in a location of the gastrointestinal (GI) tract associated with the time point, and a liquid volume of the GI tract at a location associated with the time point; (b) designing the oral drug dosage form to release the drug based on the simulated drug release profile thereby designing the oral drug dosage form formulated and configured to provide the target PK profile; printing the oral drug dosage form based on the design of the oral drug dosage form.

In some embodiments, the method comprises 3D printing an oral drug dosage form described herein.

As used herein, “printing,” “three-dimensional printing,” “3D printing,” “additive manufacturing,” or equivalents thereof, refers to a process that produces three-dimensional objects, such as drug dosage forms, layer-by-layer using digital designs. The basic process of three-dimensional printing has been described in U.S. Pat. Nos. 5,204,055; 5,260,009; 5,340,656; 5,387,380; 5,503,785; and 5,633,021. Additional U.S. patents and patent applications that related to three-dimensional printing include: U.S. Pat. Nos. 5,490,962; 5,518,690; 5,869,170; 6,530,958; 6,280,771; 6,514,518; 6,471,992; 8,828,411; U.S. Publication Nos. 2002/0015728; 2002/0106412; 2003/0143268; 2003/0198677; 2004/0005360. The contents of the above U.S. patents and patent applications are hereby incorporated by reference in their entirety.

In some embodiments, an additive manufacturing technique is used to produce an oral drug dosage form described herein. In some embodiments, a layer-by-layer technique is used to produce an oral drug dosage form described herein.

Different 3D printing methods have been developed for drug dosage form manufacturing in terms of raw materials, equipment, and solidification. These 3D printing methods include binder deposition (see Gibson et al., Additive Manufacturing Technologies: 3D Printing, Rapid Prototyping, and Direct Digital Manufacturing., 2nd ed. Springer, New York, 2015; Katstra et al., Oral dosage forms fabricated by three dimensional printing, J Control Release, 66, 2000; Katstra et al., Fabrication of complex oral delivery forms by three dimensional printing, Dissertation in Materials Science and Engineering, Massachusetts Institute of Technology, 2001; Lipson et al., Fabricated: The New World of 3D printing, John Wiley & Sons, Inc., 2013; Jonathan, Karim 3D printing in pharmaceutics: a new tool for designing customized drug delivery systems, Int J Pharm, 499, 2016), material jetting (see Jonathan, Karim, 3D printing in pharmaceutics: a new tool for designing customized drug delivery systems, Int J Pharm, 499, 2016), extrusion (see Gibson et al., Additive Manufacturing Technologies: 3D Printing, Rapid Prototyping, and Direct Digital Manufacturing. 2nd ed. Springer, New York, 2015), and photopolymerization (see Melchels et al., A review on stereolithography and its application in biomedical engineering. Biomaterials, 31, 2010).

In some embodiments, the oral drug dosage forms described herein are 3D printed using an extrusion method. In some embodiments, the method of 3D printing comprises using a double screw extrusion method. In an extrusion process, material is extruded from robotically-actuated printing heads through printing nozzles. Unlike binder deposition, which requires a powder bed, extrusion methods can print on any substrate. A variety of materials can be extruded for three-dimensional printing, including thermoplastic materials disclosed herein, pastes and colloidal suspensions, silicones, and other semisolids. One common type of extrusion printing is fused deposition modeling, which uses solid polymeric filaments for printing. In fused deposition modeling, a gear system drives the filament into a heated nozzle assembly for extrusion (see Gibson et al., Additive Manufacturing Technologies: 3D Printing, Rapid Prototyping, and Direct Digital Manufacturing, 2nd ed. Springer, New York, 2015).

In some embodiments, the 3D printing methods described herein comprise a continuous feed method.

In some embodiments, the 3D printing methods described herein comprise a batch feed method.

In some embodiments, the 3D printing is carried out by fused deposition modeling (FDM). In some embodiments, the 3D printing is carried out by non-filament FDM. In some embodiments, the 3D printing is carried out by melt extrusion deposition (MED). In some embodiments, the 3D printing is carried out by inkjet printing. In some embodiments, the 3D printing is carried out by selective laser sintering (SLS). In some embodiments, the 3D printing is carried out by stereolithography (SLA or SL). In some embodiments, the 3D printing is carried out by PolyJet, Multi-Jet Printing System (MJP), Perfactory, Solid Object Ultraviolet-Laser Printer, Bioplotter, 3D Bioprinting, Rapid Freeze Prototyping, Benchtop System, Selective Deposition Lamination (SDL), Laminated Object Manufacutring (LOM), Ultrasonic Consolidation, ColorJet Printing (CJP), EOSINT Systems, Laser Engineered Net Shaping (LENS) and Aerosol Jet System, Electron Beam Melting (EBM), Laser CUSING®, Selective Laser Melting (SLM), Phenix PXTM Series, Microsintering, Digital Part Materialization (DPM), or VX System.

In some embodiments, the three-dimensional printing is carried out by hot melt extrusion coupled with a 3D printing technique, such as FDM.

In some embodiments, the three-dimensional printing is carried out by melt extrusion deposition (MED). In some embodiments, the melt extrusion deposition technique comprises preparing a material to be dispensed, such as preparing a powder in a hot melt extruder, and then feeding the material into a MED printing head. The MED printing head then dispenses the material to form the delayed sustained-release oral drug dosage form in an additive manner (layer-by-layer deposition). In some embodiments, each material of the drug dosage form, such as a first component and a swellable component, is dispensed from a different MED printing head. In some embodiments, the MED printing head dispenses the material according to instructions compiled in one or more gcode files. Exemplary MED techniques are disclosed in, e.g., WO2019/137333, WO2018137686, and U.S. Pat. No. 10,201,503, each of which is incorporated herein by reference in its entirety.

In some embodiments, the methods for producing an oral drug dosage form described herein comprise a 3D printing technique, such as 3D printing in combination with another method, e.g., a combination of injection molding and 3D printing.

The method instructions for 3D printing a drug dosage form disclosed herein may be generated a variety of ways, including direct coding, derivation from a solid CAD model, or other means specific to the 3D printing machine's computer interface and application software. These instructions may include information on the number and spatial placement of droplets, and on general 3D print parameters such as the drop spacing in each linear dimension (X, Y, Z), and volume or mass of fluid per droplet. For a given set of materials, these parameters may be adjusted in order to refine the quality of structure created. The overall resolution of the structure created is a function of the powder particle size, the fluid droplet size, the print parameters, and the material properties.

Because 3D printing may handle a range of pharmaceutical materials and control both composition and architecture locally, 3D printing is well suited to the fabrication of oral drug dosage forms with complex geometry and composition in accordance with the present invention.

The oral drug dosage forms and components thereof described in the present application can be printed on a commercial scale. For example, in some embodiments, the methods disclosed herein may be used to 3D print oral drug dosage forms at a suitable commercial rate.

Manufacturing the drug dosage forms using 3D printing methods also facilitates personalized medicine. Personalized medicine refers to stratification of patient populations based on biomarkers to aid therapeutic decisions and personalized dosage form design. Modifying digital designs is easier than modifying physical equipment. Also, automated, small-scale three-dimensional printing may have negligible operating cost. Hence, 3D printing can make multiple small, individualized batches economically feasible and enable personalized dosage forms designed to improve adherence.

Personalized drug dosage forms allow for tailoring the amount of drug delivered based on a patient's height, weight, biochemical parameters, genetics, or metabolism, and any combination thereof. 3D printed dosage forms could ensure accurate dosing in growing children or permit personalized dosing of highly potent drugs. Personalized dosage forms can also combine all of patients' medications into a single daily dose, thus improving patients' adherence to medication and treatment compliance.

In some embodiments, the method for 3D printing comprises designing the oral drug dosage form as described herein based on a simulated drug release profile configured to obtain a target PK profile, and printing the designed oral drug dosage form. In some embodiments, the method comprises inputting parameters of the simulated drug release profile and/or the oral drug dosage form into a computer system. In some embodiments, the method comprises providing one or more parameters to be printed, e.g., layer surface area, thickness, drug mass fraction, erosion rate, compartment size, compartment release timing. In some embodiments, the methods comprise creating a virtual image of the oral drug dosage form to be printed. In some embodiments, the method comprises creating a computer model that contains the pre-determined parameters. In some embodiments, the method comprises providing the pre-determined parameters to a 3D printer and printing the item according to such pre-determined parameters. In some embodiments, the method comprises creating a 3D drawing of the item to be printed based on the pre-determined parameters, wherein the 3D drawing is created on a computer system. In some embodiments, the method comprises converting, such as slicing, a 3D drawing into 3D printing code, e.g., G code. In some embodiments, the method comprises using the computer system to execute 3D printing code, thereby printing according to the methods described herein.

Those skilled in the art will recognize that several embodiments are possible within the scope and spirit of the disclosure of this application. The disclosure is illustrated further by the examples below, which are not to be construed as limiting the disclosure in scope or spirit to the specific procedures described therein.

In some embodiments, provided is a method of producing an oral drug dosage form, the method comprising printing the oral drug dosage form, wherein the oral drug dosage form is designed to provide a target pharmacokinetic (PK) profile for a drug in an individual, the design method comprising: (a) generating a drug absorption rate profile for the drug in the gastrointestinal (GI) based on mathematical deconvolution of the target PK profile to remove therefrom from a disposition profile of the drug (such as a disposition profile based on the PK profile of the drug following intravenous bolus administration of the drug); (b) simulating the drug concentration-permeability interplay as a function of time and/or location to identify drug concentration and permeability combinations that satisfies the drug absorption rate profile, wherein the drug concentration and permeability value combinations are identified as technically feasible or non-ideal, (c) determining a GI drug requirement amount profile based on the drug concentration-permeability interplay simulation and a drug concentration and permeability combinations that satisfies the drug absorption rate profile, a drug concentration time or location profile, and a GI liquid volume time or location profile; (d) determining a cumulative drug release profile based on the GI drug requirement amount profile, thereby designing an oral drug dosage form formulated and configured to provide the target PK profile for the drug in the individual; and (e) designing the oral drug dosage form based on the cumulative drug release profile, wherein the method of producing comprises printing the designed oral drug dosage form. In some embodiments, the oral drug dosage form is a multi-compartment oral drug dosage form configured to release the drug (and any functional excipients if needed) based on the cumulative drug release profile. In some embodiments, non-ideal drug concentration and permeability value combinations are subjected to an optimization strategy thereby resulting in a drug concentration and permeability combinations that satisfies the drug absorption rate profile. In some embodiments, the optimization strategy comprises modulating (such as increasing) solubility kinetics, modulating (such as enhancing) apparent permeability, or modulating (such as inhibiting) drug degradation, or any combination thereof. In some embodiments, the drug is an ionizable drug, such as a weak acid or weak base at the GI physiological pH range. In some embodiments, for ionizable drugs, the total solubility is sum of that for ionized and non-ionized species equilibrated by pH-pKa relationship (Henderson-Hasselbalch equation), wherein the non-ionized has a much larger permeability than the ionized species of the drug. In some embodiments, the drug is a non-ionizable drug. In some embodiments, the drug is a non-ionizable drug, wherein the total solubility is based on the non-ionized molecule. In some embodiments, the apparent or net permeability may include negative efflux pump effect. In some embodiments, the use of an efflux inhibitor may increase the apparent permeability. In some embodiments, the method further comprises in vitro testing (such as via a drug release study in biorelevant media, e.g., simulated gastric and/or intestinal fluids) to optimize the oral drug dosage form.

### EXAMPLES

### Example 1

This example demonstrates the design of an oral drug dosage form formulated and configured to provide a target pharmacokinetic (PK) profile for a drug in a human individual.

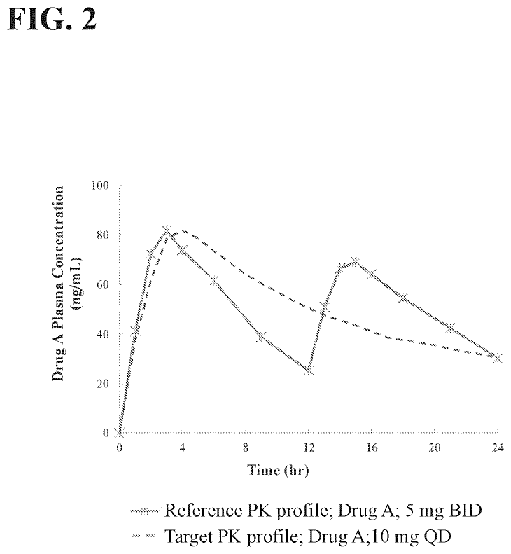

A reference PK profile covering a 24-hour period was obtained for an administration regimen of a reference oral drug dosage form containing 5 mg of Drug A (FIG. 2). The reference PK profile of Drug A represents the plasma concentration (ng/ ml) of Drug A in an individual when administered the reference oral drug dosage form twice in a 24-hour period (BID; administration occurred at the 0 hour time point and the 12 hour time point).

A target PK profile was determined based on the reference PK profile (FIG. 2). The target PK profile was designed to be bioequivalent (based on having the same AUC_{0-24,} Cₘₐₓ, and C₂₄) to the reference PK profile, wherein the target PK profile is based on a once-daily administration (QD) of an oral drug dosage form containing 10 mg of Drug A.

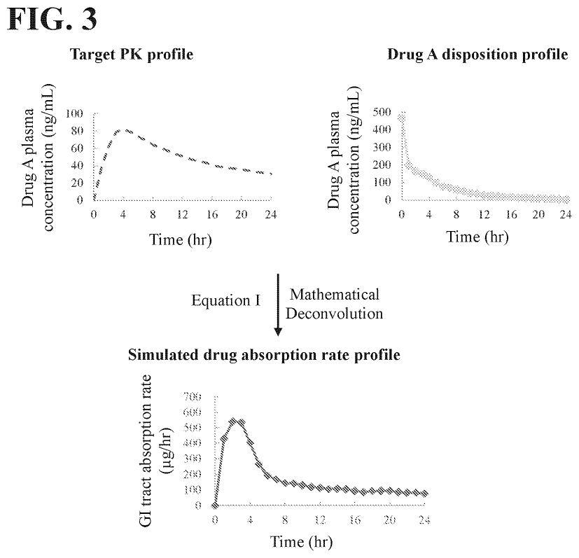

As shown in FIG. 3, using the target PK profile, a drug absorption rate profile required to achieve the target PK profile was determined. Specifically, the target PK profile was first deconvoluted using mathematical deconvolution and a disposition profile of Drug A. The deconvolution was performed using Matlab software. The disposition profile of Drug A was obtained from a human clinical study of Drug A following intravenous bolus (IV) administration. The amount of Drug A that was administered intravenously was bioequivalent to the amount of orally administered considering the reported oral bioavailability of Drug A. As discussed above, the once-daily oral drug dosage form was designed to have a total amount of Drug A in the oral dosage form of 10 mg, producing the same total daily dose as the reference drug given as 5 mg BID. The bioavailability of Drug A when administered orally was known to be about 43.1% in humans. The drug absorption rate profile was determined using one hour time increments.

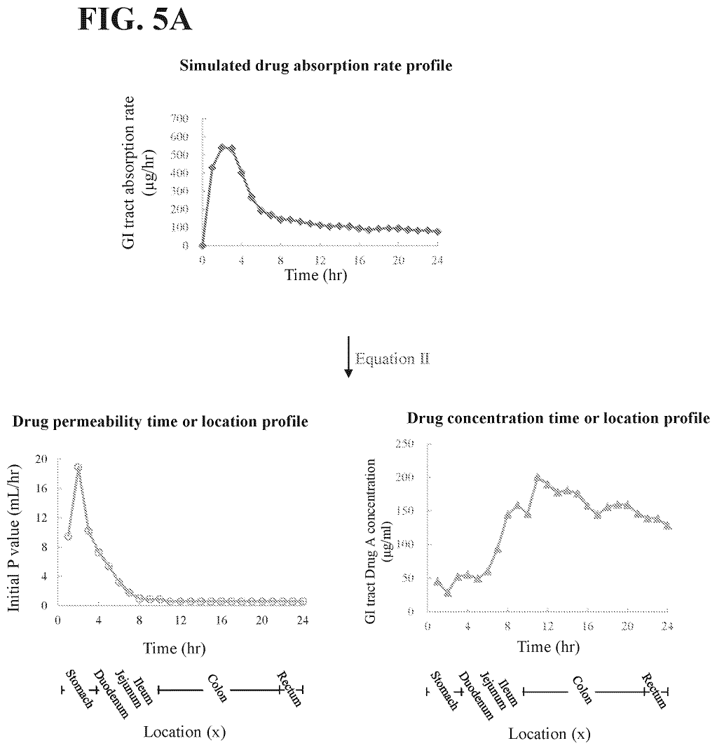

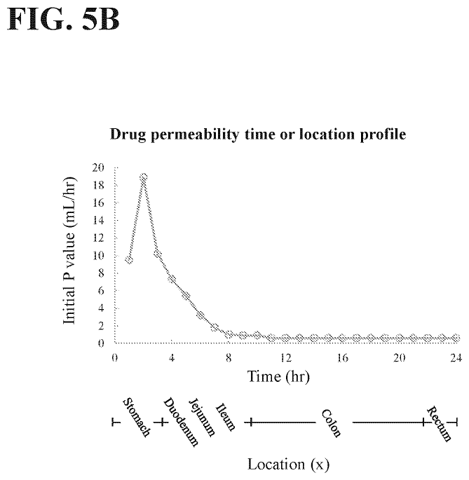

Using the calculated drug absorption rate profile, a concentration time or location profile was determined for Drug A. As depicted in FIG. 5A, the drug concentration time or location profile was based on the absorption rate profile and the drug permeability time or location profile for Drug A, wherein the drug permeability time or location profile comprises the permeability value for the drug in locations of the GI tract or at times post administration. As taught herein, the location of the drug in the GI tract can be related to a time post administration of the drug. As illustrated in FIG. 5B, the drug permeability time or location profile can be based on location (e.g., based on residence time information of the oral drug dosage form relative to locations along the GI tract) and/or time post administration. The concentration time or location profile for Drug A was calculated using Equation II. Equation II is:

q_{abs}(t/x)=C(t/x)×P(t/x), Equation II,

where C (t/x) is the concentration of Drug A soluble for absorption from the oral drug dosage form as a function of time or location, where q_{abs}(t/x) is the absorption rate of Drug A as a function of time or location, and where P(t/x) is the permeability of Drug A as a function of time or location. Similar to the profiles above, the drug concentration time or location profile was determined using one hour time increments.

The permeability time or location profile was determined from data obtained following a clinical study administering specially designed dosage forms that release drug in specific location of the GI tract and containing an oral solution of Drug A to study regional GI absorption. The permeability value of a drug permeability time or location profile accounts for the intestinal surface area of a location of the GI tract associated with the permeability value. As described herein, the drug permeability time or location profile can be based on various states of the individual, including a fed or fasted state. The permeability time or location profile for Drug A provided in FIGS. 5A and 5 was calculated based on the fed state condition. Similar to the drug permeability time or location profile, time following oral administration can be associated with the expected location of the dosage form within the GI tract (see FIG. 5A). As shown in FIGS. 5A and 5B, the permeability time or location profile for Drug A was determined using one hour time increments.

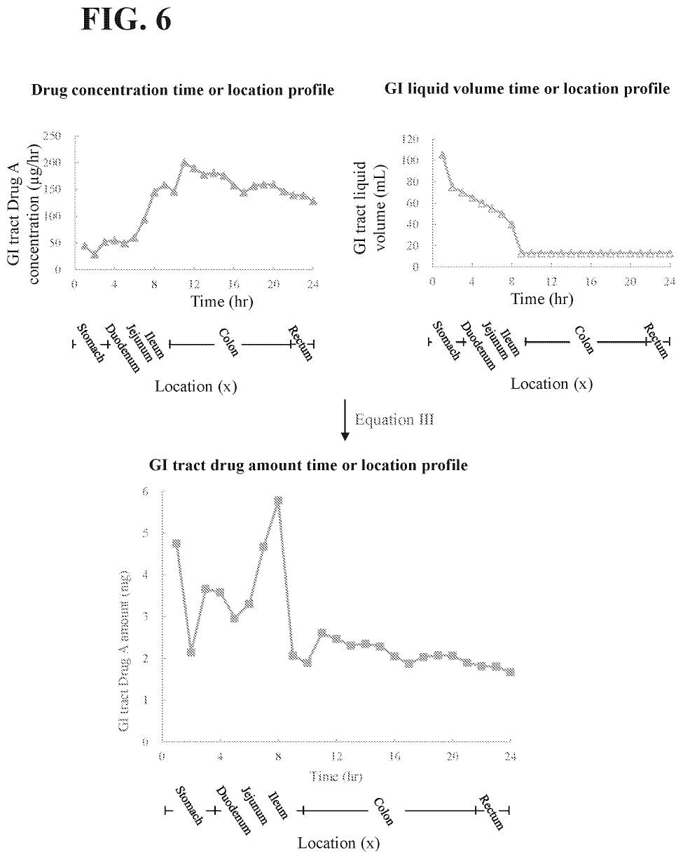

Using the concentration time or location profile, a GI drug requirement amount profile was determined. Specifically, as shown in FIG. 6, the GI drug requirement amount profile was determined using the drug concentration time or location profile and a GI liquid volume time or location profile and Equation III. Equation III is:

Q_{GIT}(t/x)=C_{GIT}(t/x)×V_{GIT}(t/x), Equation III,

where Q_{GIT}(t/x) is the amount of Drug A required for absorption from the oral drug dosage form as a function of time or location, where C_{GIT}(t/x) is the concentration of Drug A soluble for absorption from the oral drug dosage form as a function of time or location, and where V_{GIT}(t/x) is the liquid volume of the GI tract segment as a function of time or location. The liquid volume of the GI tract is associated with the state of an individual, such as during a fed state or a fasting state and estimated accordingly. As discussed above, the permeability time or location profile for Drug A was calculated based on the residence time assumption of a fed state, and, accordingly, the GI liquid volume time or location profile used reflects a fed state. The GI liquid volume time or location profile used for this example was obtained from literature values. Similar to the profiles above, the GI drug requirement amount profile was determined using one hour time increments.

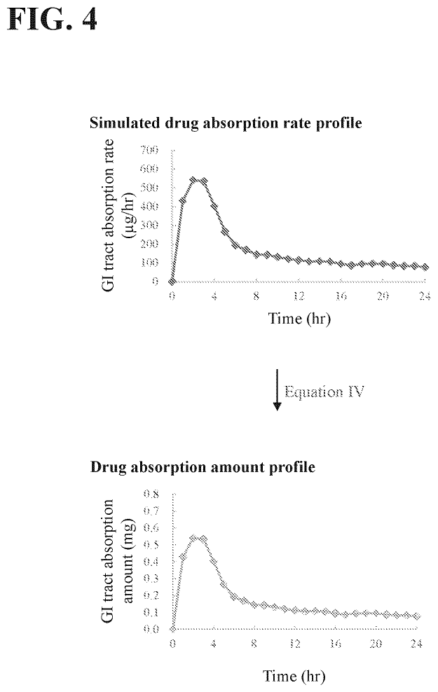

Using the drug absorption rate profile for Drug A, a drug absorption amount profile was determined for Drug A. Specifically, as illustrated in FIG. 4, the drug absorption amount profile for Drug A was determined using the drug absorption rate profile and Equation IV. Equation IV is:

Q_{abs}(t)=q_{abs}(t)×Δt, Equation IV,

where Q_{abs}(t) is the amount of Drug A absorbed from the oral drug dosage form as a function of time, and where q_{abs}(t) is the absorption rate of Drug A as a function of time. Similar to the profiles discussed above, the drug absorption amount profile for Drug A was determined using one hour time increments.

Next, the simulated drug release profile designed to obtain the target PK profile was determined based on the drug absorption amount profile and the GI drug requirement amount profile using Equation V. Equation V is:

Q_{GI release}(tᵢ/xᵢ)=[Q_{GIT}(tᵢ/xᵢ)+Q_{abs}(tᵢ)]−[Q_{GIT}(tᵢ₋₁/xᵢ₋₁)−Q_{abs}(tᵢ₋₁)], Equation V,

where Q_{GI release}(tᵢ/xᵢ) is the amount of the drug released from the oral drug dosage form at a time of tᵢ or GI tract location of xᵢ, where Q_{GIT}(tᵢ/xᵢ) is the amount of Drug A required for absorption in the GI tract from the oral drug dosage form at a time of tᵢ or GI tract location of xᵢ, where Q_{GIT}(tᵢ₋₁/xᵢ₋₁) is the amount of Drug A required for absorption in the GI tract from the oral drug dosage form at a time of tᵢ₋₁ or GI tract location of xᵢ₋₁ and where Qabs (tᵢ) is the amount of Drug A absorbed from the oral drug dosage form at a time of tᵢ, and Q_{abs}(tᵢ₋₁) is the amount of Drug A absorbed from the oral drug dosage form at a time of tᵢ₋₁ Similar to the profiles above, the simulated drug release profile was determined using hour time increments.

In determining the amount of Drug A needing to be released from the oral drug dosage form at each time point in order to obtain the target PK profile, the cumulative amount of drug released from the oral drug dosage form was determined. The cumulative amount of drug release was determined using Equation VI. Equation VI is:

Q_{GI cumulative release}(t)=Σ₀^{t}[Q_{Gi release}(t)×Δt], Equation VI,

where Q_{GI cumulative release}(t) is the cumulative amount of Drug A released from the oral drug dosage form as a function of time, and where Q_{GI release}(t) is the amount of Drug A released from the oral drug dosage form as a function of time. Alternatively, the cumulative amount of Drug a released from the oral drug dosage form can be determined using Equation VII. Equation VII is:

Q_{GI cumuatlive release}(t)=∫₀^{t}Q_{Gi release}(t)dt, Equation VII.

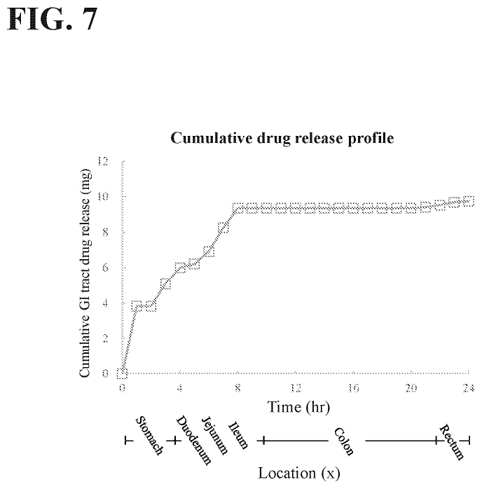

FIG. 7 provides a profile illustrating the total cumulative release of Drug A over time to obtain the target pK profile.

Additionally, techniques for optimization of the absorption of Drug A were explored. As illustrated in FIG. 8A, the solubility was evaluated as compared to the drug concentration time or location profile. For most of the GI tract drug concentration time profile, the concentrations predicted to be present in the GI tract based on the design methods described herein, exceeded the expected solubility of Drug A (FIG. 8A). Thus, the solubility of Drug A was modulated using optimization methods described herein such that the enhanced solubility limit was now above the required GI tract concentrations at all time points (FIG. 8A) Additionally, as depicted in FIG. 8B, modulation of drug permeability, and timing thereof, was explored to determine the impact on the drug concentration time or location profiles. FIG. 8B illustrates the impact of changes in Drug A permeability on the drug concentration time or location profile when (a) permeability was enhanced to 1.4 times the original permeability values from 0 to 24 hours after administration, (b) permeability was enhanced to 1.4 times the original permeability values from 3 (jejunum) to 24 hours after administration, (c) permeability was enhanced to 1.4 times the original permeability values from 8 (colon) to 24 hours after administration, and (d) permeability was enhanced to 1.8 times the original permeability values from 8 (colon) to 24 hours after administration. Such approaches can be used alone or in combination with other optimization techniques.

Based on the information regarding the release of Drug A from the oral drug dosage form, the oral drug dosage form was designed to release drug accordingly, thus providing an oral drug dosage form formulated and configured to provide the target PK profile.

1. A method of designing an oral drug dosage form formulated and configured to provide a target pharmacokinetic (PK) profile for a drug in an individual, the method comprising:
(a) determining a simulated drug release profile configured to obtain the target PK profile,
wherein the simulated drug release profile comprises an amount of the drug released from the oral drug dosage form at a plurality of time points over a pre-determined time course, and
wherein each time point or location of the simulated drug release profile is determined based on an amount of the drug absorbed at the time point, a permeability value for the drug in a location of the gastrointestinal (GI) tract associated with the time point, and a liquid volume of the GI tract at a location associated with the time point; and
(b) designing the oral drug dosage form to release the drug based on the simulated drug release profile thereby designing the oral drug dosage form formulated and configured to provide the target PK profile.

2. The method of claim 1, further comprising determining the amount of the drug absorbed from the oral drug dosage form at each time point.

3. The method of claim 1, wherein the amount of the drug absorbed from the oral drug dosage form at each time point is based on a drug absorption rate profile,
wherein the drug absorption rate profile comprises an uptake rate of the drug at the plurality of time points to obtain the target PK profile.

4. The method of any one of claims 1, wherein the amount of the drug absorbed from the oral drug dosage form is based on Equation IV,
Q_{abs}(t)=q_{abs}(t)×Δt, Equation IV,
where Q_{abs}(t) is the amount of the drug absorbed from the oral drug dosage form as a function of time, and
where q_{abs}(t) is the absorption rate of the drug as a function of time.

5. The method of claim 3, further comprising determining the drug absorption rate profile.

6. The method of claim 4, wherein the drug absorption rate profile is based on deconvolution of the target PK profile with a disposition profile of the drug according to Equation I:
$${q}_{abs} ( t ) = {L}^{- 1} [ \frac{L \{ {C}_{p , oral} ( t ) \}}{L \{ {C}_{p , disposition} ( t ) \}} ] , \qquad Equation I$$
where L and L⁻¹ are Laplace transform and inverse Laplace transform,
where q_{abs}(t) is based on the drug absorption rate profile as a function of time, and
where C_{p,oral}(t) and C_{p,disposition}(t) are based on the plasma level concentration profile as a function of time of oral administration and disposition, respectively.

7-11. (canceled)

12. The method of claim 1, further comprising determining an amount of the drug required for absorption in a location of the GI tract from the oral drug dosage form at the time point or location, wherein the amount of drug required for absorption in a location of the GI tract from the oral drug dosage form at the time point or location is based on the permeability value for the drug in a location of the GI tract associated with the time point or location, and the liquid volume of the GI tract at a location associated with the time point or location.

13. The method of claim 12, wherein the amount of the drug required for absorption in a location of the GI tract from the oral drug dosage form at the time point or location is based on a drug concentration time or location profile and a GI liquid volume time or location profile.

14. The method of claim 13, wherein the amount of the drug required for absorption in a time or location of the GI tract from the oral drug dosage form is based on Equation III,
Q_{GIT}(t/x)=C_{GIT}(t/x)×V_{GIT}(t/x), Equation III,
where Q_{GIT}(t/x) is the amount of the drug required for absorption from the oral drug dosage form as a function of time or location,
where C_{GIT}(t/x) is the concentration of the drug soluble for absorption from the oral drug dosage form as a function of time or location, and
where V_{GIT}(t/x) is the liquid volume of the GI tract as a function of time or location.

15-17. (canceled)

18. The method of claim 13, further comprising determining the drug concentration time or location profile.

19. The method of claims 13, wherein the drug concentration -location profile is based on the drug absorption rate profile and a drug permeability time or location profile, wherein the drug permeability time or location profile comprises the permeability value for the drug in a location of the GI tract associated with each time point of the plurality of time points.

20. The method of claim 19, wherein the drug concentration-location profile is based on Equation II,
q_{abs}(t/x)=C(t/x)×P(t/x), Equation II,
where C(t/x) is the concentration of the drug soluble in GI tract from the oral drug dosage form as a function of time or location,
where q_{abs}(t/x) is the absorption rate of the drug as a function of time or location, and
where P(t/x) is the permeability as a function of time or location.

21-22. (canceled)

23. The method of claim 1, further comprising designing the oral drug dosage form based on modulating the solubility of the drug or the permeability of the drug.

24. (canceled)

25. The method of claim 1, further comprising optimizing the simulated drug release profile.

26. The method of claim 1, further comprising determining a cumulative drug release profile based on the simulated drug release profile.

27-35. (canceled)

36. A method of designing an oral drug dosage form formulated and configured to provide a target pharmacokinetic (PK) profile for a drug in an individual, the method comprising:
(a) determining a drug absorption rate profile based on deconvolution of a target PK profile using a disposition profile, and a total amount of a drug in the oral drug dosage form;
(b) determining a drug absorption amount profile based on the drug absorption rate profile;
(c) determining a drug concentration time or location profile based on the simulated drug absorption rate profile and a permeability time or location profile for the drug,
(d) determining a GI drug requirement amount profile based on the drug concentration time or location profile and a GI liquid volume time or location profile;
(e) determining a simulated drug release profile configured to obtain the target PK profile based on the drug absorption amount profile and the GI drug requirement amount profile,
wherein the simulated drug release profile comprises an amount of the drug released from the oral drug dosage form to obtain the target PK profile; and
(f) designing the oral drug dosage form to release the drug based on the simulated drug release profile thereby designing the oral drug dosage form formulated and configured to provide the target PK profile.

37. (canceled)

38. The method of claim 36, further comprising determining a cumulative drug release profile based on the simulated drug release profile.

39. An oral drug dosage form comprising a drug formulated and configured to have a target pharmacokinetic (PK) profile, wherein the oral drug dosage form is formulated and configured to release the drug based on a design obtained from the method of claim 1.

40. (canceled)

41. A method of making an oral drug dosage form comprising a drug formulated and configured to have a target pharmacokinetic (PK) profile, the method comprising three-dimensional (3D) printing the oral drug dosage form based on a design of the oral drug dosage form obtained from the method of claim 1.

42. A method of making an oral drug dosage form comprising a drug formulated and configured to have a target pharmacokinetic (PK) profile, the method comprising three-dimensional (3D) printing the oral drug dosage form based on a design of the oral drug dosage form obtained from a method comprising:
(a) determining a drug absorption rate profile based on deconvolution of a target PK profile using a disposition profile, and a total amount of a drug in the oral drug dosage form;
(b) determining a drug absorption amount profile based on the drug absorption rate profile;
(c) determining a drug concentration time or location profile based on the drug absorption rate profile and a permeability time or location profile for the drug, (d) determining a GI drug requirement amount profile based on the drug concentration time or location profile and a GI liquid volume time or location profile;
(e) determining a simulated drug release profile configured to obtain the target PK profile based on the drug absorption amount profile and the GI drug requirement amount profile,
wherein the simulated drug release profile comprises an amount of the drug released from the oral drug dosage form to obtain the target PK profile; and
(f) designing the oral drug dosage form to release the drug based on the simulated drug release profile thereby designing the oral drug dosage form formulated and configured to provide the target PK profile.
